(19) United States
(12) Patent Application Publication
(10) Pub. No.: US 2025/0116364 A1
(43) Pub. Date: Apr. 10, 2025

(54) SYSTEMS AND METHODS FOR PIPE REPAIR USING RAPID SINTERING

(71) Applicant: UNIVERSITY OF MARYLAND, COLLEGE PARK, College Park, MD (US)

(72) Inventors: Liangbing HU, Rockville, MD (US); Paul ALBERTUS, Takoma Park, MD (US); Qi DONG, Newton, MA (US); Chengwei WANG, College Park, MD (US)

(21) Appl. No.: 18/293,763

(22) PCT Filed: Aug. 5, 2022
(86) PCT No.: PCT/US2022/039598

§ 371 Date: Jan. 30, 2024

Related U.S. Application Data
(60) Provisional application No. 63/229,848, filed on Aug. 5, 2021.

(51) Int. Cl. F16L 55/175; F16L 55/162

(52) U.S. Cl. CPC F16L 55/175; F16L 55/162

(57) ABSTRACT

A first slurry can be applied over a surface of an existing pipe to form a first layer. The first slurry can comprise a powder, a binder, and a solvent. The powder can comprise a metal. At least some of the powder in the first layer can be sintered to form a new pipe portion by subjecting a portion of the first layer to a first temperature for a first time period. The first temperature can be greater than a melting temperature of the metal. The sintered first layer forming the new pipe portion can be effective to repair or recondition the existing pipe. In some embodiments, the sintered first layer can form at least part of a separate pipe within and/or contacting the existing pipe.

### CROSS-REFERENCE TO RELATED APPLICATION(S)

The present application claims the benefit of U.S. Provisional Application No. 63/229,848, filed Aug. 5, 2021, entitled “Rapid Sintering of Metal Coatings for Pipe Repair,” which is incorporated by reference herein in its entirety.

### STATEMENT REGARDING FEDERALLY SPONSORED RESEARCH

This invention was made with government support under DEAR0001329 awarded by the Department of Energy (DOE), Advanced Research Projects Agency-Energy (ARPA-E). The government has certain rights in the invention.

### FIELD

The present disclosure relates generally to pipe repair, and more particularly, to rapid sintering to form a metal coating for pipe repair.

### BACKGROUND

There are about 20,000 miles of cast iron pipes and about 40,000 miles of bare steel pipes in the United States, a large percentage of which are due for replacement or repair. However, existing methods for repairing metal pipes are expensive or generate metal components insufficient for long-term pipe use. For example, directed energy deposition (DED) is a known additive manufacturing technique that employs laser/arc metal deposition. While DED has been used for manufacturing metal or alloy components, components fabricated by DED can have a high surface roughness (e.g., >50 μm) and residual stress, which can affect the mechanical stability of any fabricated pipe or repaired portion thereof over its lifetime (e.g., 50 years of use).

In another example, laser melting can be used to form a metal layer. However, laser melting also introduces surface roughness to the resulting components due to locally high temperatures. To avoid anisotropic properties, components formed by laser melting may require specially designed heat treatments. Moreover, laser melting for powder based additive manufacturing can require high quality spherical shape powders with a specific size distribution, which directly impacts the build quality. Laser melting techniques may also require complex and expensive instruments that would not be suitable for on-site operation to repair a pipe. Even if laser melting systems could be employed within a pipe for repair, the relatively small laser beam size and relatively slow scan rate would significantly limit its application for scalable pipe-in-pipe deposition process.

In another example, a metal layer can be formed via a thermal spray, where molten metals or alloys are accelerated (e.g., through a Laval nozzle) in an inert atmosphere to be atomized and then deposited onto a cool substrate. Again, the expensive and complex equipment required for thermal spray may limit its ability to cost-effectively repair metal pipes. In addition, due to particle erosion, the nozzle throat of the thermal spray equipment is subject to extensive wear, which in turn leads to poor quality coatings (e.g., low density and poor uniformity). Additionally, metal layers formed by thermal spray can be limited to relatively thin thicknesses (e.g., <1 mm) with low bonding to the underlying material.

Embodiments of the disclosed subject matter may address one or more of the above-noted problems and disadvantages, among other things.

### SUMMARY

Embodiments of the disclosed subject matter system provide repair of an existing metal pipe, for example, by depositing and sintering a metal coating on a surface of the pipe. In some embodiments, an existing pipe can be repaired in situ in a relatively low-cost, highly-reliable manner. In some embodiments, a portion of an existing pipe can be repaired by the sintered metal coating (e.g., a patch). Alternatively or additionally, a new replacement pipe within the existing pipe can be formed by the sintered metal coating (e.g., a pipe-in-pipe configuration). In some embodiments, the new replacement pipe may serve as a structural element (e.g., capable of withstanding about the same or greater forces than the original pipe), not just a non-structural coating designed to block or prevent leakage. In some embodiments, the pipe repair can employ a Joule-heating element (e.g., strip or bar) to sinter the deposited coating, for example, by providing high-temperature radiation sintering (HRS) (e.g., with the heating element spaced from the deposited pre-sintered coating) or high-temperature conduction sintering (e.g., with the heating element in contact with the deposited pre-sintered coating).

In some embodiments, one or more metal powders with micron-scale particle sizes (e.g., ˜50 μm or less) can be mixed with a polymeric binder (e.g., ˜1-5 wt %) and a solvent to form a slurry. The slurry can then be coated onto a target pipe surface (e.g., an inner or outer wall of an existing pipe, or a joint) and optionally at least partially dried (e.g., via evaporation of the solvent). The metal powder layer can then be sintered by a short-duration exposure (e.g., ˜10-60 s) to a high-temperature (e.g., about or greater than a melting temperature of the metal, for example, ˜2000° C.) by a heating element. In some embodiments, the heating element can scan over the metal powder layer at a close distance (e.g., ˜5 mm or less) to sinter the powder layer, thereby forming a solid metal layer that can serve as a new pipe or repaired pipe portion. In some embodiments, the sintered metal layer (e.g., steel) can have a relative density (e.g., relative to a nominal density of the metal) of at least 80% (e.g., up to 95%, or even greater than 95%) and/or a thickness in a range of ˜1-5 mm.

In one or more embodiments, a method can comprise (a) applying a first slurry over a surface of an existing pipe to form a first layer. The first slurry can comprise a powder, a binder, and a solvent. The method can further comprise (b), after (a), sintering at least some of the powder in the first layer to form a new pipe portion by subjecting a portion of the first layer to a first temperature for a first time period. The powder can comprise a metal. The first temperature can be greater than a melting temperature of the metal.

In one or more embodiments, a structure can comprise first and second pipes. The second pipe can be a sintered layer of metal formed in situ over an inner circumferential wall of the first pipe.

In one or more embodiments, a pipe repair system can comprise a slurry application device, a sintering device, and a control system. The control system can be operatively coupled to the slurry dispensing device and the sintering device. The control system can comprise one or more processors and computer readable storage media storing instructions that, when executed by the one or more processors, cause the control system to (i) control the slurry application device to apply a first slurry over a surface of an existing pipe to form a first layer, the first slurry comprising a powder, a binder, and a solvent, and (ii) control the sintering device to sinter at least some of the powder in the first layer to form a new pipe portion by subjecting a portion of the first layer to a first temperature for a first time period. The first temperature can be about or greater than a melting temperature of a metal of the powder.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1A is a simplified cross-sectional view of an existing metal pipe to which embodiments of the disclosed subject matter are applicable.

FIG. 1B is a simplified cross-sectional view illustrating a slurry application phase of an exemplary pipe repair method, according to one or more embodiments of the disclosed subject matter.

FIG. 1C is a simplified cross-sectional view illustrating a densification phase of an exemplary pipe repair method, according to one or more embodiments of the disclosed subject matter.

FIG. 1D is a simplified cross-sectional view illustrating a sintering phase of an exemplary pipe repair method, according to one or more embodiments of the disclosed subject matter.

FIG. 1E is a magnified cross-sectional view of an inner circumferential surface portion of the repaired pipe, according to one or more embodiments of the disclosed subject matter.

FIG. 1F illustrates optional removal of the existing pipe for use of the sintered metal coating as a replacement pipe, according to one or more embodiments of the disclosed subject matter.

FIG. 1G illustrates an optional repaired pipe configuration with multiple sintered metal coatings, according to one or more embodiments of the disclosed subject matter.

FIG. 2 illustrates phases of another exemplary pipe repair method employing an intervening insulating layer, according to one or more embodiments of the disclosed subject matter.

FIG. 3 is a simplified schematic diagram of a pipe repair system, according to one or more embodiments of the disclosed subject matter.

FIGS. 4A-4C are simplified cross-sectional views showing operations of exemplary slurry application devices employing a brush, doctor blade, and extrusion nozzle, respectively, according to one or more embodiments of the disclosed subject matter.

FIGS. 5A-5B are simplified cross-sectional views showing operations of exemplary densifying devices employing a roller and a radial-pressing mechanism, respectively, according to one or more embodiments of the disclosed subject matter.

FIGS. 6A-6B are simplified cross-sectional views showing operations of exemplary sintering devices employing a U-shaped heating element and a V-shaped heating element, respectively, according to one or more embodiments of the disclosed subject matter.

FIGS. 6C-6D are simplified cross-sectional views showing operations of exemplary sintering devices employing heating elements with multiple apices, respectively, according to one or more embodiments of the disclosed subject matter.

FIG. 6E is a simplified isometric view showing operations of an exemplary sintering device employing a rod-shaped heating element.

FIG. 6F is a simplified cross-sectional view of an exemplary sintering device employing multiple curved heating elements, according to one or more embodiments of the disclosed subject matter.

FIGS. 7A-7B are simplified plan and side views, respectively, of an exemplary heating element having a narrowed thickness, according to one or more embodiments of the disclosed subject matter.

FIGS. 7C-7D are simplified plan and side views, respectively, of an exemplary heating element having a narrowed width, according to one or more embodiments of the disclosed subject matter.

FIGS. 7E-7F are simplified plan and side views, respectively, of an exemplary heating element having both a narrowed width and thickness, according to one or more embodiments of the disclosed subject matter.

FIG. 8 depicts a generalized example of a computing environment in which the disclosed technologies may be implemented.

FIG. 9 is a process flow diagram of an exemplary method for repairing a pipe, according to one or more embodiments of the disclosed subject matter.

FIG. 10A is a magnified cross-sectional view of an inner circumferential surface portion of a pipe repaired with a self-healing coating, according to one or more embodiments of the disclosed subject matter.

FIG. 10B illustrates aspects of a self-healing process of the repaired pipe of FIG. 10A, according to one or more embodiments of the disclosed subject matter.

FIG. 10C is a graph illustrating the variation of the transformation temperature between low-temperature B19′ martensite phase and high-temperature B2 austenite phase in NiTi shape memory alloy.

FIG. 11A is a graph of normalized light intensity versus wavelength corresponding to different temperatures of a Joule heating element. FIG. 11B is a graph of X-ray powder diffraction (XRD) of a sintered alloy with pure phase.

FIG. 11C shows a thermal model of a pipe subjected to heating by a Joule heating element.

FIG. 11D is a graph of steady-state temperature distribution within the pipe determined using the thermal model of FIG. 11C.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein, but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following explanations of specific terms and abbreviations are provided to facilitate the description of various aspects of the disclosed subject matter and to guide those skilled in the art in the practice of the disclosed subject matter.

Sintering temperature: A maximum temperature at a surface of a heating element when energized (e.g., by application of a current pulse). In some embodiments, the sintering temperature is about or greater than a melting temperature of metal particles in a deposited slurry. In some embodiments, the temperature is at least 1500° C., for example, approximately 2000° C. In some embodiments, a temperature at the deposited slurry (e.g., at a surface facing or in contact with the heating element) can match or substantially match (e.g., within 10%) the temperature of the heating element.

Particle size: A maximum cross-sectional dimension (e.g., diameter) of each particle in a slurry. In some embodiments, an identified particle size represents an average particle size for all particles in the slurry (e.g., an average of the maximum cross-sectional dimensions). In some embodiments, an identified particle size represents an average particle size for subsets of particles in the slurry, for example, having a bimodal distribution of particle sizes. In some embodiments, the particle size can be measured according to one or more known standards, such as, but not limited to, ASTM B214-16 entitled “Standard Test Method for Sieve Analysis of Metal Powders,” ASTM B330-20 entitled “Standard Test Methods for Estimating Average Particle Size of Metal Powders and Related Compounds Using Air Permeability,” ASTM B822-20 entitled “Standard Test Method for Particle Size Distribution of Metal Powders and Related Compounds by Light Scattering,” and ASTM B922-20 entitled “Standard Test Method for Metal Powder Specific Surface Area by Physical Adsorption,” all of which are incorporated by reference herein.

Inert gas: A gas that does not undergo a chemical reaction when subjected to the sintering temperature and any materials present. In some embodiments, the inert gas is nitrogen, argon, helium, neon, krypton, xenon, radon, oganesson, or any combination of the foregoing.

Pipe repair: For an existing metal pipe, providing a sintered metal coating over some or all of a circumferential surface of the pipe. In some embodiments, the sintered metal coating can enhance the strength of the existing pipe, mitigate defects (e.g., cracks) in the wall of the existing pipe, and/or extend a service life of the existing pipe. In some embodiments, the provision of a sintered metal coating for pipe repair may be considered a reconditioning, e.g., without explicit detection of any defects in the existing pipe wall. In some embodiments, the provision of a sintered metal coating for pipe repair forms a new pipe wall that can operate in place of (e.g., by removing the existing pipe or allowing the existing pipe to degrade in place) or in conjunction with (e.g., as a pipe-in-pipe configuration) the existing pipe.

Metal: Includes those individual chemical elements classified as metals on the periodic table, including alkali metals, alkaline earth metals, transition metals, lanthanides, and actinides, as well as alloys formed from such metals, such as, but not limited to, steel (e.g., stainless steel), brass, bronze, monel, etc.

### Introduction

In one or more embodiments, an existing metal pipe (e.g., a steel or cast iron pipe, for example, having an inner diameter of 10 inches) can be repaired by forming a new metal layer thereon via application of a rapid pulse (e.g., ˜60 seconds or less, such as ˜10 seconds or less) of high temperature (e.g., greater than a melting temperature of the metal and/or greater than 1500° C., such as ˜ 2000° C.) to sinter a metal powder coating. In some embodiments, the pipe repair can occur in situ (e.g., with the existing pipe remaining in its previously installed location, such as buried underground, and/or with the existing pipe continuing in active operation, such as conveying natural gas). In some embodiments, a portion of the existing pipe can be repaired by the sintered metal coating (e.g., a patch). Alternatively or additionally, a new replacement pipe within the existing pipe can be formed by the sintered metal coating (e.g., a pipe-in-pipe configuration).

In some embodiments, the existing metal pipe repair can involve at least precursor deposition and subsequent sintering. For precursor deposition, one or more metal powders with micron-scale particle sizes (e.g., <1 mm, such as ˜50 μm or less) can be mixed with a polymeric binder (e.g., ˜1-5 wt %) and a solvent to form a slurry. In some embodiments, the metal powders for the slurry can be composed of micron-scale particles of the metal itself (e.g., steel, such as American Petroleum Institute (API) X100 steel) and/or micron-scale particles of the constituent metal (e.g., Fe, Mn, Ni, Cr). The slurry can be coated onto a target pipe surface (e.g., an inner or outer wall of an existing pipe) and optionally at least partially dried (e.g., via evaporation of the solvent) prior to sintering. The slurry can have a composition and viscosity that allows for substantially conformal application to arbitrary surfaces (e.g., sharp corners or bends) that may normally be present in a network of pipes.

The metal powder layer can be sintered by a short-duration exposure (e.g., ˜10-60 s) to a high temperature (e.g., about or greater than a melting temperature of the metal, for example, ˜2000° C.) by a heating element. In some embodiments, the heating element can have a curved configuration and/or be flexible to allow adoption of a curved configuration, for example, to allow sintering of uneven surfaces (e.g., corners or bends). For example, the heating element can be a Joule-heating element (e.g., a strip or bar of carbon), which can generate a radiation spectrum that is broadband and thus not material specific (e.g., able to sinter a range of different materials). In some embodiments, the heating element can scan over the pre-sintered slurry layer at a close distance (e.g., ˜5 mm or less) or in contact therewith, while a current pulse is continuously or periodically applied to the heating element to generate the short-duration high temperature, thereby sintering the powder layer to form a solid metal layer that can serve as a new pipe or repaired pipe portion. In some embodiments, the sintered metal layer (e.g., steel) can have a relative density (e.g., relative to a nominal density of the metal) of at least 80% (e.g., up to 95%, or even greater than 95%), a thickness in a range of ˜1-5 mm, inclusive, and/or be substantially-free of voids or connected pores (e.g., to be leak-tight with respect to a gas or liquid carried by the pipe).

In some embodiments, the new pipe formed by sintered metal layer can be retained within the existing pipe (e.g., a pipe-in-pipe configuration), for example, to allow the new pipe to take over service when the existing pipe becomes out of service and/or to extend a service life of the existing pipe. In some embodiments, the new pipe (e.g., an outer circumferential surface) can be in contact with and/or coupled to the existing pipe (e.g., an inner circumferential surface). Alternatively, in some embodiments, the existing pipe can be removed from the new pipe or otherwise allowed to degrade, such that the new pipe alone continues to provide fluid conveying service.

### Sintered Metal Coatings for Pipe Repair

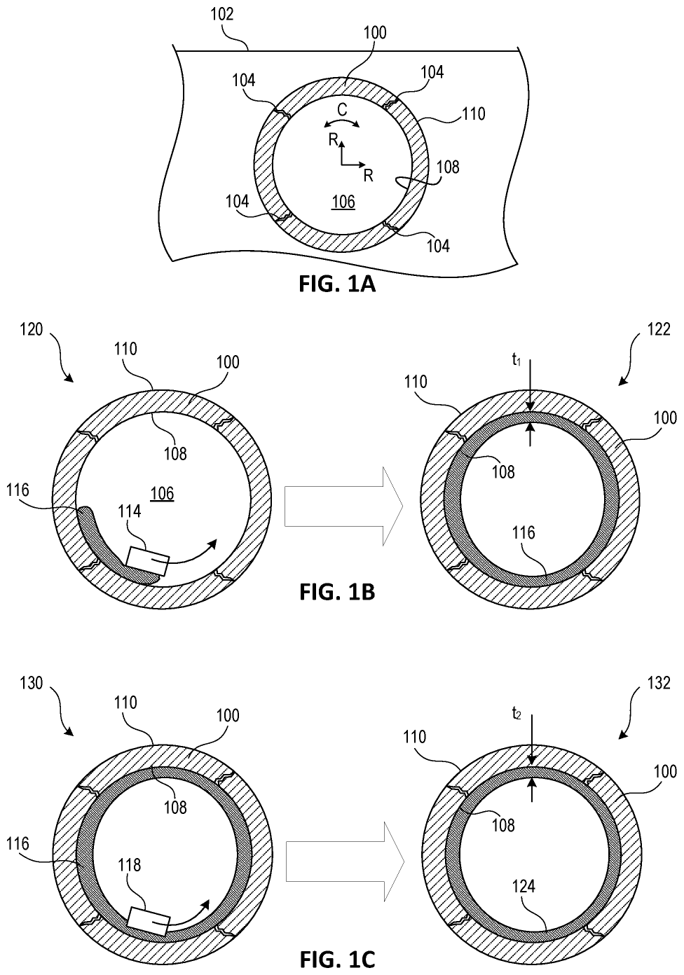

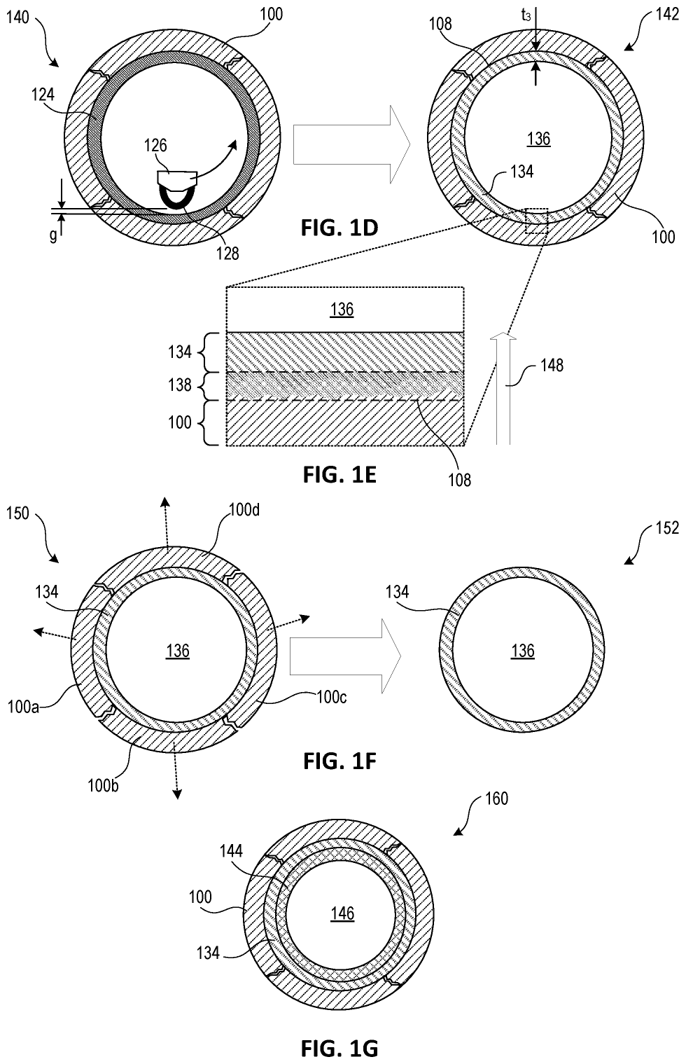

FIG. 1A shows an installation of an existing pipe 100, for example, buried within the ground 102 (or other surrounding material, such as a wall or floor of a building). The existing pipe 100 can have an annular wall that defines an inner circumferential surface 108, an outer circumferential surface 110, and an interior volume 106 bounded by the inner circumferential surface 108. Fluid (e.g., liquid or gas, such as natural gas which comprises methane) can be carried by the interior volume 106 along an axial direction A (perpendicular to a cross-sectional plane containing the circumferential direction C and the radial direction R, e.g., perpendicular to the page in FIG. 1A) of pipe 100. In some embodiments, the existing pipe can have an inner diameter along the radial direction R of at least 8 inches and may be considered, for example, a pipe main. The existing pipe 100 can have one or more defects 104 (e.g., cracks) in the wall and/or may be nearing the end of its intended service lifetime (e.g., 50 years from installation).

In some embodiments, the existing pipe 100 can be repaired, reconditioned, and/or replaced by sintering a metal powder slurry coated coating over part or all of a circumferential surface (e.g., inner surface 108) of the pipe 100. For example, FIG. 1B illustrates a slurry application stage 120 for repairing pipe 100. In the illustrated example, a slurry application device 114 can be used to spread, extrude, print, dispense, or otherwise apply a slurry 116 onto the inner circumferential surface 108 of the pipe 100. In some embodiments, the slurry can be applied to an entire circumference of the inner surface 108, for example, as shown at 122, to form a substantially conformal layer having a thickness t₁ along the radial direction, for example, less than or equal to 5 mm (e.g., 2-5 mm, inclusive, such as about 3 mm). In some embodiments, the slurry application device 114 can apply the slurry layer 116 on the surface 108 via a brush, a spatula or doctor blade, an extrusion nozzle (e.g., printhead, syringe), a spray nozzle, or a conduit (e.g., dispensing pipe).

In some embodiments, the slurry can be a mixture (e.g., mechanical mixing) of one or more metal powders, one or more binders, and one or more solvents. In some embodiments, the slurry 116 can consist essentially of (e.g., consist of) the one or more metal powders, the one or more binders, and the one or more solvents. The composition of the slurry can be adjusted (e.g. by varying respective amounts/concentrations of powder, binder, and solvent) to provide a viscosity of the slurry that allows it to be applied as a conformal coating from the slurry application device 114 and to remain in place on the pipe surface prior to and during sintering. For example, the slurry can have a viscosity in a range of 0.5 Pa-s to 5 Pa-s, inclusive.

The one or more metal powders can comprise elemental metals (e.g., aluminum, titanium), metal alloys (e.g., steel, such as X100 steel or stainless steel 316L), and/or constituents for forming metal alloys (e.g., iron, manganese, nickel, and chromium). In some embodiments, particles in the powder cab have a particle size that is in the micron-scale (e.g., less than 1 mm, such as 150 μm or less), for example, 50 μm or less (e.g., 10 μm or less, such as ˜5 μm). Alternatively or additionally, the powder can have a distribution of particle sizes, for example, such that an average or median particle size is in the micron-scale (e.g., less than 1 mm), for example, 50 μm or less (e.g., ˜5 μm). Alternatively or additionally, the powder can have a multi-modal distribution of particle sizes, for example, a bimodal distribution of particle sizes, such as a first set of particles having an average particle size greater than 10 μm (e.g., about 50 μm) and a second set of particles having an average particle size less than or equal to 10 μm (e.g., about 5 μm).

In some embodiments, the one or more binders can comprise a polymeric binder, such as a wax or water-soluble polymer. For example, the polymeric binder can include poly (vinylpolypyrrolidone) (PVP), polyvinyl alcohol (PVA), or both PVP and PVA. In some embodiments, an amount of the polymer binder(s) in the slurry can be less than or equal to 5 wt %, for example, in a range of 1-5 wt % inclusive, such as about 3 wt %. In some embodiments, the solvent can be water or an organic solvent, for example, an alcohol solvent. For example, the solvent can include methanol, ethanol, isopropyl alcohol (IPA), acetone, or any combination thereof.

In some embodiments, the slurry layer applied to the existing pipe can be compacted or densified prior to sintering. For example, FIG. 1C illustrates a densification stage 130 where a densification device 118 can be used to radially press the deposited slurry layer 116 into a denser coating. For example, as shown at 132, the densification device 118 can form a substantially uniform layer 124 having a thickness t₂ along the radial direction that is, for example, at least 10% less than t₁. For example, after the pressing by densification device 118, the thickness can be reduced from a t₁ of ˜3 mm to a t₂ of ˜2.5 mm. In some embodiments, the densification device 118 can be formed of a material that does not stick (or at least resists adhering) to the applied slurry, for example, a polymer such as glass, a ceramic, a polymer (e.g., polypropylene, polytetrafluoroethylene (PTFE), etc.) or combinations thereof. In some embodiments, the densification device 118 can employ a roller (e.g., that rolls along the surface of layer 116 about the circumferential direction) or a curved platen (e.g., that moves along the radial direction perpendicular to the surface of layer 116).

In some embodiments, the slurry layer (either after densification or without any densification) can be partially or fully dried (e.g., to remove some or all of the solvent therefrom), for example, by air drying, forced air flow, infrared irradiation, or any combination thereof. In some embodiments, the slurry layer (after densification, after drying, or without any densification or drying) can be subjected to a sintering temperature (e.g., ≥1500° C., such as ˜2000 ° C.), for example, about or greater than a melting temperature of a metal powder of the slurry layer, such that the metal powder is sintered into a solid metal layer. For example, FIG. 1D illustrates a sintering stage 140 where a sintering head 126 with a Joule heating element 128 (e.g., formed of carbon, silicon carbide, metal, or any combination thereof) can be used to generate the sintering temperature. In some embodiments, the Joule heating element 128 can expose a portion of the slurry layer 124 to the sintering temperature for a short period of time (e.g., ≤60 seconds, such as ˜10 seconds) so as to convert the exposed portion into the solid metal layer.

As shown in FIG. 1D, during sintering, the heating element 128 can be spaced along the radial direction from a facing surface of the slurry layer 124 by a gap of 5 mm or less, for example, to provide radiative heating. Alternatively, in some embodiments, the heating element 128 can be in contact with the surface of the slurry layer 124, for example, to provide conductive heating. In some embodiments, a current pulse can be applied to the Joule heating element 128 to generate sintering temperature, and the Joule heating element 128 can be constructed to rapidly heat (e.g., a heating ramp rate of at least 10²° C./s, such as at least 10³° C./s or at least 10⁴° C./s, or a heating ramp rate in a range of 10² to 10⁴° C./s, inclusive) to the sintering temperature (e.g., from room temperature, such as 20-25° C., or from an ambient temperature within the pipe that is less than 500° C.) and/or to rapidly cool (e.g., a cooling ramp rate of at least 10²° C./s, such as at least 10³° C./s or at least 10⁴° C./s, or a cooling ramp rate in a range of 10² to 10⁴° C./s, inclusive) from the sintering temperature (e.g., back to room temperature, such as 20-25° C., or back to an ambient temperature within the pipe that is less than 500° C.). In some embodiments, a gas flow (e.g., inert gas) can be directed at the heating element and/or the recently-sintered metal layer to enhance cooling (e.g., to achieve a cooling ramp rate in a range of 10² to 10⁴° C./s).

In some embodiments, after sintering of a first portion of slurry layer 124, the sintering head 126 can then move along the circumferential direction to expose a next portion of the slurry layer 124 to the sintering temperature, which exposure and circumferential movement can be repeated until an entire annular metal pipe 134 is formed within the existing pipe 100, as shown at 142. In some embodiments, the new pipe 134 can have a thickness t₃ along the radial direction that is, for example, less than or equal to 5 mm (e.g., 2-5 mm, inclusive, such as about 3 mm), and can define a new inner volume 136 for conveying a fluid.

In some embodiments, the heating via sintering head 126 can be effective to define a metal inner pipe 134 in contact with and adhered to the inner circumferential surface 108 of the existing pipe 100. The short-pulse, high-temperature heating can be effective to minimize residual stress in the sintered pipe layer 134 and/or avoid formation of detrimental material phases. Alternatively or additionally, in some embodiments, the heating via sintering head 126 can be effective to define a transition layer 138 intervening between (e.g., in contact with) the metal inner pipe 134 and the existing pipe 100, as shown in FIG. 1E. In some embodiments, the transition layer 138 can be un-sintered or partially sintered slurry. For example, the short-pulse, high-temperature heating can be effective to form a gradient 148 of material properties between the existing pipe 100, the transition layer 138 and/or the sintered inner pipe 134. In some embodiments, the material properties of the gradient 148 may be density, mechanical strength (e.g., yield strength), hardness, adhesion, etc. For example, a radially-inner part of the pipe layer 134 (e.g., facing inner volume 136) can have a density, hardness, and/or strength greater than that of the radially-outer part of the pipe layer 134 (e.g., facing existing pipe 100) and/or the transition layer 138.

In some embodiments, the transition layer can be a separate layer added prior to slurry application in stage 120 and constructed to improve adhesion of layer 134 after sintering to the existing pipe 100. Alternatively, in some embodiments, the transition layer can be constructed to decrease adhesion of layer 134 to the existing pipe 100. For example, after sintering, the existing pipe 100 can be divided into sections 100a-100d and removed from the inner pipe 134 at pipe removal stage 150, thereby leaving the inner pipe 134 alone to provide service, as shown at stage 152 in FIG. 1F. Alternatively, instead of dividing into sections, the existing pipe 100 can be removed as a whole by displacing the existing pipe along its axial direction. Alternatively, the existing pipe 100 can be maintained in place and allowed to degrade over time, while the inner pipe 134 remains to provide service independently.

In some embodiments, the slurry application stage of FIG. 1B (with or without optional densification stage of FIG. 1C) and the sintering stage of FIG. 1D can be repeated. For example, FIG. 1G shows an exemplary configuration 160 of an inner pipe formed of a first sintered layer 134 over an inner circumferential surface of the existing pipe 100 and a second sintered layer 144 over an inner circumferential surface of the first sintered layer 134. In some embodiments, the first sintered layer 134 and the second sintered layer 144 can be formed of substantially the same material and/or have substantially the same material properties, for example, to form an inner pipe of increased thickness (e.g., >5 mm). Alternatively, in some embodiments, the first sintered layer 134 can be formed of a different material and/or have different material properties from the second sintered layer 144, for example, to provide a circumferential surface bounding inner volume 146 that is more resistant to a chemical flowing therethrough. Although FIG. 1G illustrates only two sintered layers 134, 144, three or more sintered layers are also possible according to one or more contemplated embodiments.

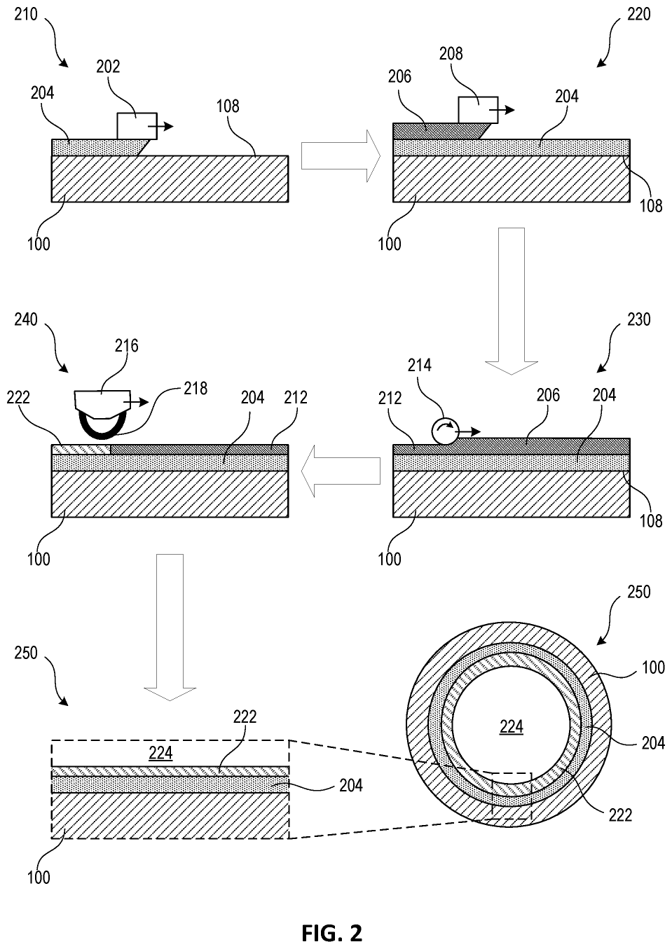

Some existing pipes (e.g., iron-based pipes) may have and/or be attached to plastic components, which may not be able to survive high temperatures in a vicinity of sintering operations. Alternatively or additionally, for environmental or safety concerns, it may be beneficial to ensure the high temperature of the sintering is not conveyed through the wall of the existing pipe, for example, to avoid generation of steam on the exterior of the existing pipe. For example, in some embodiments, it may be desirable to maintain a temperature at an exterior surface of the existing pipe to be no more than about ˜75° C. Accordingly, in some embodiments, an insulating layer can be formed between the slurry and the existing pipe. For example, as shown in FIG. 2, the insulating layer 204 can be dispensed by an application device 202 (e.g., brush, a spatula or doctor blade, an extrusion nozzle, a spray nozzle, or a conduit) onto or over the existing pipe 100 during deposition stage 210. Other techniques for depositing or forming the insulating layer 204 are also possible according to one or more contemplated embodiments, such as vapor deposition, sputtering, chemical reaction (e.g., oxidation), etc.

At slurry application stage 220, a slurry 206 can be applied by slurry application device 208 onto or over the insulating layer 204, for example, in a manner similar to that described above with respect to FIG. 1B. At densification stage 230, the applied slurry 206 can be densified by densification device 214 (e.g., roller) to form densified slurry layer 212, for example, in a manner similar to that described above with respect to FIG. 1C. At sintering stage 240, a Joule-heating element 218 of sintering head 216 can be used to serially sinter the slurry layer 212 into a solid metal coating 222, for example, in a manner similar to that described above with respect to FIG. 1D. In some embodiments, the insulating layer 204 can serve a protective function, for example, to prevent, or at least reduce an amount of, heat generated by the Joule-heating element 218 during sintering stage 240 from reaching the existing pipe 100. Accordingly, the heat generated by Joule-heating element 218 can be mostly used for sintering the slurry layer 212 rather than heating the pipe 100, thereby improving energy efficiency while also avoiding high temperatures within a wall of pipe 100 and/or external to pipe 100. The final multi-layer structure 250 has a radially inner-most metal layer 222 bounding an inner volume 224 (e.g., thereby forming a new pipe), a radially outer-most existing pipe 100, and an annular insulating layer 204 intervening between the metal layer 222 and the existing pipe 100.

In some embodiments, the insulating layer 204 can be porous. Alternatively or additionally, in some embodiments, the insulating layer 204 can have a thermal conductivity that is less than that of the slurry 206, the sintered coating 222, and/or the existing pipe 100. In some embodiments, the insulating layer 204 can be formed of an oxide with a high melting temperature (e.g., having a melting temperature greater than that of a metal in the slurry), for example, SiO₂, Al₂O₃, TiO₂, etc. Alternatively, in some embodiments, the insulating layer 204 can be formed of a low thermal conductivity material, such as boron nitride. Alternatively, in some embodiments, the insulating layer 204 can comprise a portion of slurry 206 or a separate layer of slurry that has not been sintered and/or has been formed to be porous.

### Pipe Repair Systems

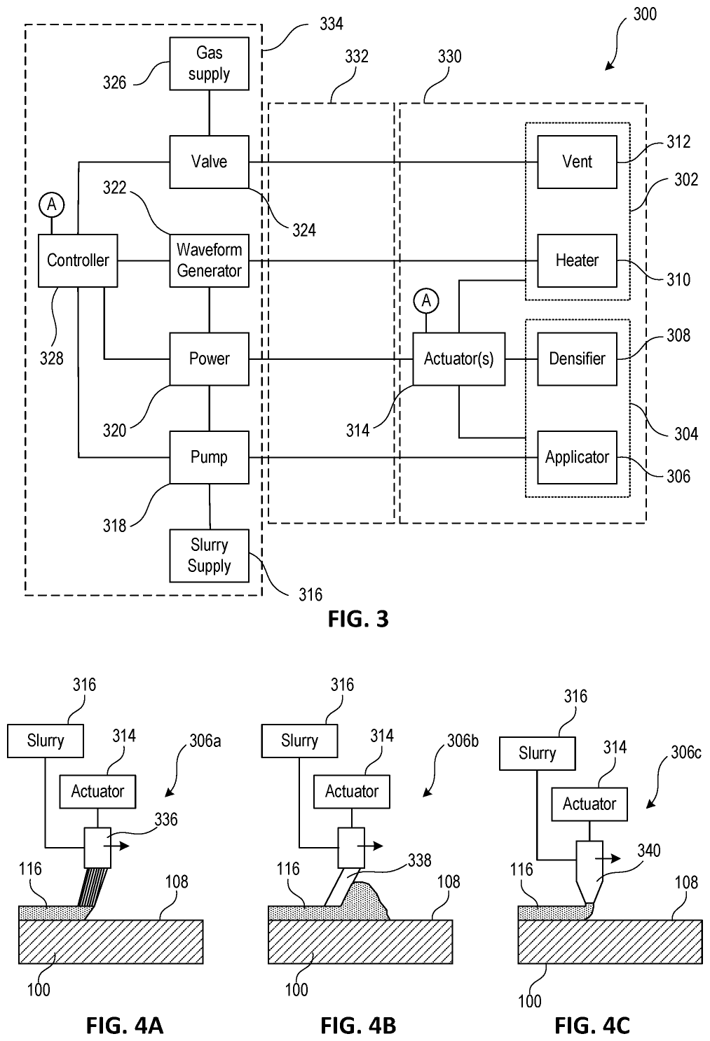

In some embodiments, a pipe repair system 300 can include a sintering head 302, a slurry head 304, an actuator assembly 314, and a control system 328, as shown in FIG. 3. The pipe repair system 300 can further include a supply 316 of slurry coupled to a pump 318 (e.g., hydraulic pump, industrial concrete pumping system, etc.), a supply 326 of inert gas coupled to one or more air control valves 324, and/or an electrical power supply 320 coupled to a waveform generator 322 (e.g., for supplying a current pulse). Alternatively or additionally, in some embodiments, system 300 can employ different components and/or can combine components together. For example, in some embodiments, waveform generator 322 can be integrated with electrical power supply 320. In another example, the air control valves can be replaced or supplemented by other conventional air handling components, for example, by using a pump to supply pressurized gas to vent 312.

In some embodiments, components 334 can be located outside (e.g., above ground) of the existing pipe being repaired, while components 330 can be located within the pipe. A supply line 332 can extend between the external components 334 and the internal components 330 to provide operative connections therebetween, for example, including an air conduit connecting valve 324 to a vent or outlet 312 of the sintering head 302, electrical wiring connecting waveform generator 322 to a Joule-heating element 310 of the sintering head 302, electrical wiring connecting power supply 320 to actuator assembly 314, and/or a hydraulic conduit connecting pump 318 to slurry application device 306.

The control system 328 can be operatively coupled to valve 324, waveform generator 322, pump 318, and/or actuator assembly 314 to control operation thereof in performing a pipe repair method. For example, the control system 328 can control actuator assembly 314 to position the slurry head 304 with respect to an inner surface of the existing pipe and then to control pump 318 to supply slurry from supply 316 to the slurry application device 306 as the the slurry head 304 is moved in a circumferential direction, thereby applying a layer of slurry to the existing pipe. Simultaneously or subsequently, the control system 328 can control the actuator assembly 314 to radially move the densifying device 308 (also referred to herein as a densification device) to press a portion of the deposited slurry and/or to circumferentially move the densifying device 308 to a next portion of the deposited slurry for pressing. The control system 328 can further control waveform generator 322 to energize the Joule-heating element 310 (e.g., by applying a current pulse) and/or to circumferentially move the heating element 310 to a next portion of the deposited slurry for sintering. Simultaneously or subsequently, the control system 328 can control the valve 324 to provide an inert gas (e.g., nitrogen, argon, helium, neon, krypton, xenon, radon, oganesson, or any combination of the foregoing) to vent 312, for example, to remove and/or dissipate heat and/or provide an inert environment to avoid undesired chemical reactions within the pipe. In some embodiments, the inert gas from vent 312 can be directed at the heating element 310, at the portion of the slurry being subjected to sintering, or both. Alternatively or additionally, in some embodiments, the inert gas can be supplied to a cross-section of the pipe, for example, via vent 312 without specifically directing at the heating element or by changing a flow of fluid through the pipe (e.g., supplying nitrogen or argon at a speed of 15 m/hour).

In some embodiments, the actuator assembly 314 can include one or more actuators coupled to the sintering head 302, the slurry head 304, or both so as to move head 302 and/or head 304 along axial and/or circumferential directions within an existing pipe. In some embodiments, each head 302, 304, and/or each component of each head 302, 304, can be coupled to separate actuators, for example, to allow independent positioning. Alternatively or additionally, in some embodiments, the components and/or heads 302, 304 can share actuators, for example, to allow simultaneous positioning. For example, the one or more actuators 314 can include motors coupled to wheels (e.g., as a pipe crawler) and/or a winding machine (e.g., rotates and traverses within the pipe). In some embodiments, the one or more actuators 314 can be configured to position head 302 and/or head 304 along a radial direction, for example, to follow an inner circumferential surface of the existing pipe and/or to maintain a predetermined spacing (e.g., <5 mm) from the inner surface of the existing pipe.

In some embodiments, the slurry application device 306 can include a brush, a spatula or doctor blade, an extrusion nozzle (e.g., printhead, syringe), a spray nozzle, or a conduit (e.g., dispensing pipe). For example, FIG. 4A illustrates an exemplary slurry application device 306a that is or comprises a brush 336. In such a configuration, the slurry can be supplied to a port in the brush 336 (e.g., flowing through bristles of the brush) and/or deposited onto the surface in front of the brush 336. In another example, FIG. 4B illustrates an exemplary slurry application device 306b that is or comprises a doctor blade 338. In such a configuration, the slurry can be supplied to a port in the blade 338 (e.g., flowing along a front surface of the blade) and/or deposited onto the surface in front of the blade 338. In yet another example, FIG. 4C illustrates an exemplary slurry application device 306c that is or comprises an extrusion nozzle 340 (e.g., printhead). In such a configuration, the slurry can be supplied to an inlet of the nozzle 340 and dispensed through an outlet tip of the nozzle.

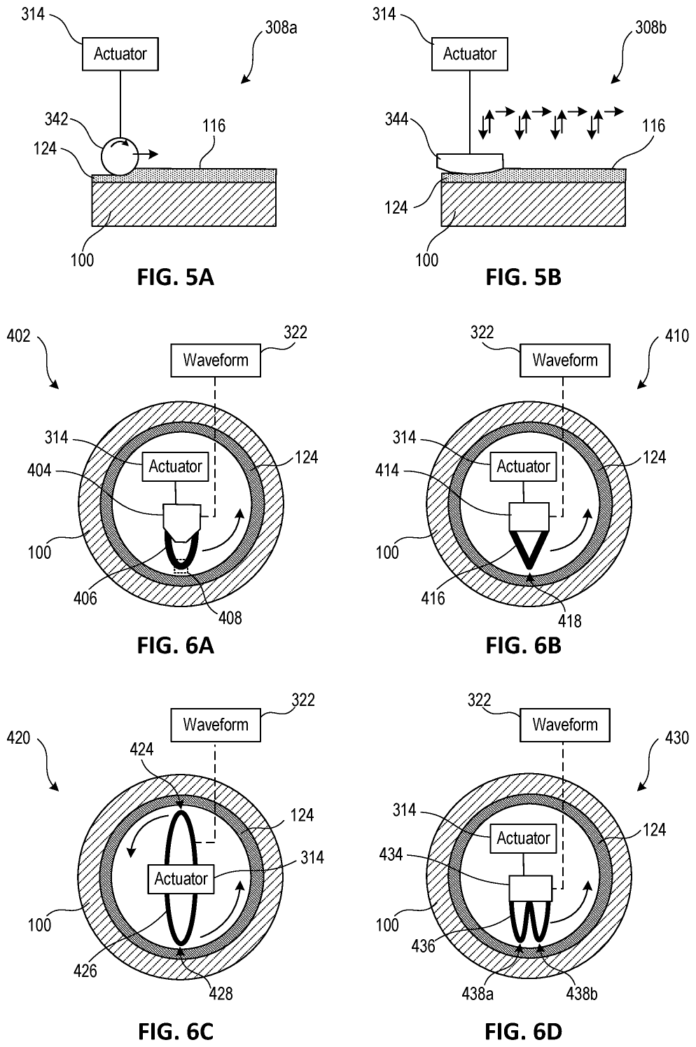

In some embodiments, the densification device 308 can include a roller (e.g., for continuous pressing) or a platen (e.g., for discontinuous or interval pressing). For example, FIG. 5A illustrates an exemplary densification device 308a that is or comprises a roller 342. In some embodiments, the roller 342 can be actively rotated, for example, such that an actuator rotates the roller 342 about its central axis in order to translate the roller 342 circumferentially as it presses. Alternatively, in some embodiments, the roller 342 can be passively rotated, for example, such that an actuator translates the roller 342 circumferentially and friction between the roller 342 and the slurry 116 causes the roller 342 to rotate about its central axis. In another example, FIG. 5B illustrates another exemplary densification device 308b that is or comprises a platen 344. In some embodiments, the platen 344 can be moved radially outward to press into a portion of slurry 116 to cause densification thereof, after which the platen 344 can be retracted and repositioned along the circumferential direction for pressing a next portion of the slurry 116.

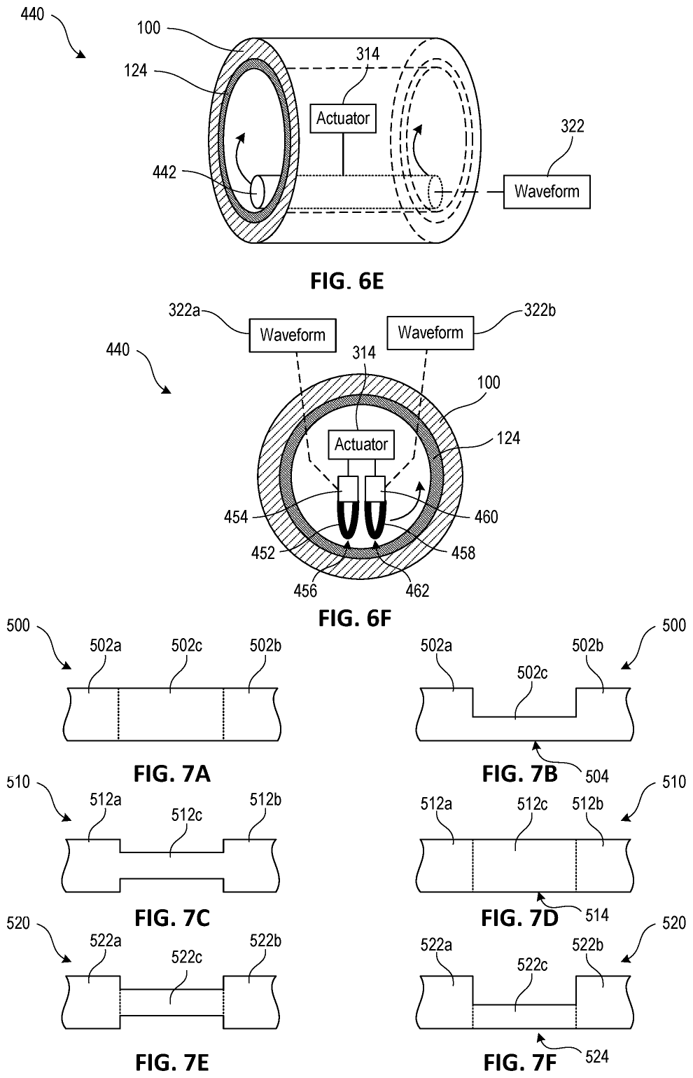

In some embodiments, the Joule-heating element 310 can have a curved (e.g., nonlinear) configuration in one or more cross-sectional views, for example, at a region of the heating element 310 closest to the slurry layer and/or designed to provide the sintering temperature. Alternatively or additionally, the Joule-heating element 310 can be formed of a flexible material so as to adopt a curved configuration, for example, to follow a curved surface of a pipe (e.g., at a bend or junction). In some embodiments, the curved heating element can have one or more peaks or apices that provide a heating spot (e.g., between 1 mm² and 10 cm²) on or proximal to the slurry layer. For example, FIG. 6A illustrates an exemplary configuration 402 employing a sintering head 404 with a substantially U-shaped heating element 406. The U-shaped heating element 406 can have an apex that defines a heating spot 408 for sintering the slurry layer 124. In another example, FIG. 6B illustrates an exemplary configuration 410 employing a sintering head 414 with a substantially V-shaped heating element 416, which may define a narrower size heating spot 418. In another example, FIG. 6C illustrates an exemplary configuration 420 employing a substantially O-shaped or oval-shaped heating element 426. By virtue of its multiple apices, the oval-shaped heating element 426 can provide a first heating spot 424 and a second heating spot 428 on a radially opposite side of the pipe 100, for example, to sinter multiple portions of the slurry layer 124 simultaneously. In another example, FIG. 6D illustrates an exemplary configuration 430 employing a sintering head 434 with a substantially W-shaped heating element 436. By virtue of its multiple apices, the W-shaped heating element 436 can provide a first heating spot 438a and a second heating spot 438b on a same side of the pipe 100, for example, to sinter multiple portions of the slurry layer 124 simultaneously. In another example, FIG. 6E illustrates an exemplary configuration 440 employing a rod-shaped heating element 442. By virtue of its curved, axially-extending surface facing the inner circumferential surface of the pipe 100, the rod-shaped heating element 442 can sinter multiple portions of the slurry layer 124 simultaneously.

In some embodiments, multiple heating elements can be used, for example, to sequentially subject the slurry to different temperatures. For example, FIG. 6F illustrates an exemplary configuration 450 employing a first sintering head 454 with a first heating element 452 and a second sintering head 460 with a second heating element 458. The first heating element 452 can be coupled to waveform generator 322a, for example, to be energized by a current pulse to generate a sintering temperature (e.g., ˜2000° C.) for heating spot 456. The second heating element 458 can be coupled to waveform generator 322b, for example, to be energized by a current pulse to generate a pre-sintering or conditioning temperature less than the sintering temperature (e.g., ˜1000° C.) for heating spot 462. In some embodiments, the pre-sintering or conditioning temperature can be used to prepare the pipe for subsequent slurry application, for example, by cleaning the pipe surface by burning off organics. Alternatively or additionally, in some embodiments, the pre-sintering or conditioning temperature can be effective to partially or fully dry the applied slurry layer (e.g., by evaporating solvent therein) prior to sintering. Although sintering heads 454 and 460 are shown separately in FIG. 6F, in some embodiments, sintering heads 454, 460 can be combined together in a single sintering head, for example, where heating elements 452 and 458 are moved together in parallel. Alternatively or additionally, although heating elements 452 and 458 are shown adjacent to each other in FIG. 6F, in some embodiments, the heating elements 452, 458 can be provided at different orientations (e.g., at a 90° arrangement, at a 180° arrangement, or any other arrangement), for example, to allow an interval between exposure to the conditioning temperature and exposure to the sintering temperature.

In some embodiments, the Joule-heating element 310 can have a narrowed cross-section, for example, at a region of the heating element 310 designed to provide the sintering temperature. The narrowed cross-section of the heating element can be effective to concentrate the heating at a region of the heating element closest to and/or touching the slurry layer, while regions of the heating element away from the slurry layer may be maintained at a lower temperature. For example, FIGS. 7A-7B illustrate a heating spot 500 (e.g., apex) of a heating element with a cross-section narrowed in a single dimension, in particular, a central region 502c having a reduced thickness (e.g., along a radial direction of the pipe) disposed between full-thickness regions 502a, 502b. Surface 504 of the reduced-thickness region 502c can face and/or contact the slurry layer or the circumferential wall of the pipe. In another example, FIGS. 7C-7D illustrate a heating spot 510 (e.g., apex) of another heating element with a cross-section narrowed in a single dimension, in particular, a central region 512c having a reduced width (e.g., along an axial direction or circumferential direction of the pipe) disposed between full-width regions 512a, 512b. Surface 514 of the reduced-width region 512c can face and/or contact the slurry layer or the circumferential wall of the pipe. In still another example, FIGS. 7E-7F illustrate a heating spot 520 (e.g., apex) of another heating element with a cross-section narrowed in two dimensions, in particular, a central region 522c having a reduced thickness and width disposed between full-size regions 522a, 522b. Surface 524 of the reduced-size region 522c can face and/or contact the slurry layer or the circumferential wall of the pipe.

### Computer Implementation

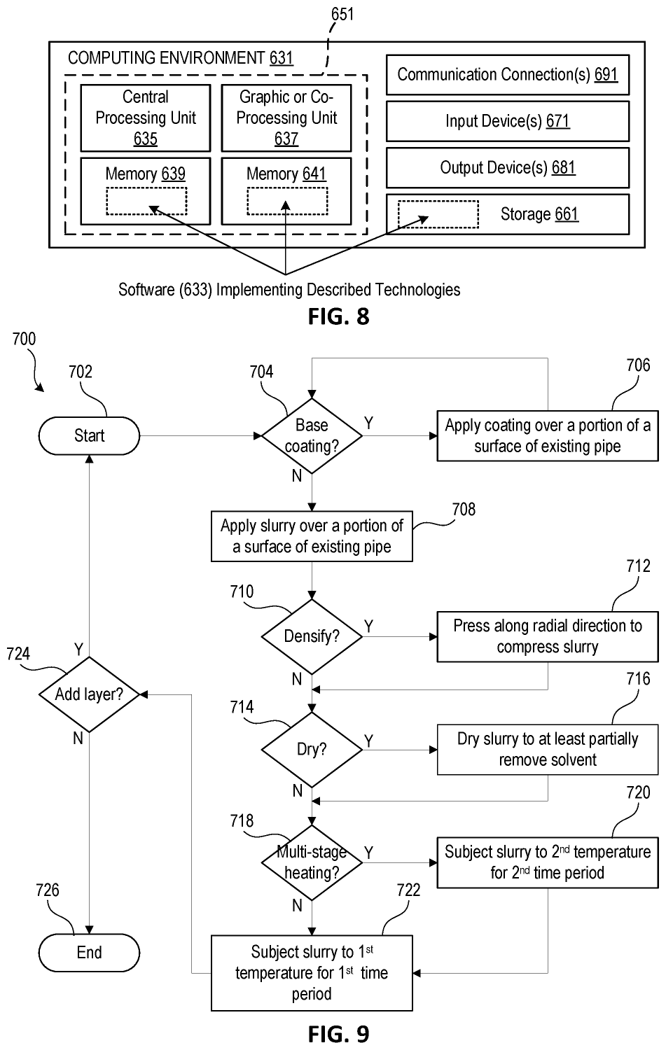

FIG. 8 depicts a generalized example of a suitable computing environment 631 in which the described innovations may be implemented, such as aspects of method 700 and/or control system 328. The computing environment 631 is not intended to suggest any limitation as to scope of use or functionality, as the innovations may be implemented in diverse general-purpose or special-purpose computing systems. For example, the computing environment 631 can be any of a variety of computing devices (e.g., desktop computer, laptop computer, server computer, tablet computer, etc.).

With reference to FIG. 8, the computing environment 631 includes one or more processing units 635, 637 and memory 639, 641. In FIG. 8, this basic configuration 651 is included within a dashed line. The processing units 635, 637 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 6F shows a central processing unit 635 as well as a graphics processing unit or co-processing unit 637. The tangible memory 639, 641 may be volatile memory (e.g., registers, cache, RAM), non-volatile memory (e.g., ROM, EEPROM, flash memory, etc.), or some combination of the two, accessible by the processing unit(s). The memory 639, 641 stores software 633 implementing one or more innovations described herein, in the form of computer-executable instructions suitable for execution by the processing unit(s).

A computing system may have additional features. For example, the computing environment 631 includes storage 661, one or more input devices 671, one or more output devices 681, and one or more communication connections 691. An interconnection mechanism (not shown) such as a bus, controller, or network interconnects the components of the computing environment 631. Typically, operating system software (not shown) provides an operating environment for other software executing in the computing environment 631, and coordinates activities of the components of the computing environment 631.

The tangible storage 661 may be removable or non-removable, and includes magnetic disks, magnetic tapes or cassettes, CD-ROMs, DVDs, or any other medium which can be used to store information in a non-transitory way, and which can be accessed within the computing environment 631. The storage 661 can store instructions for the software 633 implementing one or more innovations described herein.

The input device(s) 671 may be a touch input device such as a keyboard, mouse, pen, or trackball, a voice input device, a scanning device, or another device that provides input to the computing environment 631. The output device(s) 671 may be a display, printer, speaker, CD-writer, or another device that provides output from computing environment 631.

The communication connection(s) 691 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smartphones or other mobile devices that include computing hardware), for example, such as industrial and/or non-industrial IoT “Internet of Things” devices). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, Perl, and/or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### Pipe Repair Methods

FIG. 9 illustrates an exemplary method 700 for repairing a pipe according to one or more embodiments of the disclosed subject matter. The method 700 can initiate at terminal 702 and proceed to decision block 704, where it is determined if a base coating is desired. If a base coating is desired, the method 700 can proceed to process block 706, where the base coating is applied or otherwise formed on or over a portion (e.g., annular strip) of a surface (e.g., inner circumferential surface) of an existing pipe. In some embodiments, the base coating can be an insulating layer (e.g. similar to insulating layer 204 described above), a transition layer (e.g., similar to transition layer 138 described above), or any other type of layer. In some embodiments, the base coating can be applied using a brush, a spatula or doctor blade, a pump coupled to an extrusion nozzle, a pump coupled to a spray nozzle, a pump coupled to a conduit, or any combination thereof. Alternatively or additionally, in some embodiments, the base coating can be formed via vapor deposition, sputtering, chemical reaction (e.g., oxidation), etc. Additional base coatings can be applied by returning to decision block 704 and process block 706.

If no base coating (or no additional base coatings) is desired at decision block 704, the method 700 can proceed to process block 708, where a slurry can be applied on or over a portion of a surface (e.g., inner circumferential surface) of the existing pipe. In some embodiments, the slurry can be applied to only part of the pipe surface, for example, for spot repair or patching. Alternatively, in some embodiments, the slurry can be applied to an entire circumference (e.g., an annular strip) of the pipe, for example, to form an entirely new pipe within the existing pipe. As noted above, the slurry can be a mixture of one or more metal powders, one or more binders, and one or more solvents, for example, having a viscosity in a range of 0.5 Pa-s to 5 Pa-s, inclusive. In some embodiments, the slurry can be applied on or over the pipe surface via a brush, a spatula or doctor blade, a pump coupled to an extrusion nozzle (e.g., printhead), a pump coupled to a spray nozzle, or a pump coupled to a conduit (e.g., dispensing pipe).

The method 700 can proceed to decision block 710, where it is determined if the applied slurry should be densified prior to sintering. If densification is desired, the method 700 can proceed to process block 712, where the slurry is compressed by radially pressing against the pipe wall. For example, the densification of process block 712 can be similar to that described above with respect to FIGS. 1C, 3, 5A, and/or 5B. After densification at process block 712, or if densification was not desired at decision block 710, the method 700 can proceed to decision block 714, where it is determined if the applied slurry should be dried prior to sintering. If drying is desired, the method 700 can proceed to process block 716, wherein some or all of the solvent in the slurry is removed via evaporation. For example, the drying of process block 716 can include air drying, forced air flow, infrared irradiation, preheating (e.g., using the sintering heating element, or a separate heating element, to subject the slurry to a temperature less than the sintering temperature) or any combination thereof.

After drying at process block 716, or if drying was not desired at decision block 714, the method 700 can proceed to decision block 718, where it is determined if the applied slurry should be subjected to multi-stage heating. If multi-stage heating is desired, the method 700 can proceed to process block 720, where the slurry can be subjected to a second temperature for a second time period. The second temperature can be less than a melting temperature of a metal in the slurry. For example, the second temperature can be about 1000° C., and the second time period can be about 10 seconds (e.g., averaged to a spot). In some embodiments, subjecting the slurry to the second temperature for the second time period can be effective to remove solvent and/or binder from the slurry (e.g., to evaporate solvent and/or carbonize the binder). In some embodiments, the second temperature of process block 720 can be provided by the sintering heating element energized to a lower temperature or a separate heating element, for example, in a manner similar to that described above with respect to FIG. 6F.

After the heating of process block 720, or if multi-stage heating was not desired at decision block 718, the method 700 can proceed to process block 722, where the slurry can be subjected to a first temperature for a first time period. The first temperature can be greater than a melting temperature of a metal in the slurry. For example, the first temperature can be about 2000° C., and the first time period can be about 10 seconds (e.g., averaged to a spot). In some embodiments, subjecting the slurry to the first temperature for the first time period can be effective to sinter the slurry into a solid metal layer. In some embodiments, the first time period may initiate immediately after the conclusion of the second time period, for example, such that the temperature proceeds directly to the first temperature from the second temperature. Alternatively, the first time period may be delayed after the second time period, for example, such that the temperature drops below the second temperature (e.g., dropping to room or ambient temperature) before increasing to the first temperature. In some embodiments, the first temperature of process block 722 can be provided by the sintering heating element, for example, in a manner similar to that described above with respect to FIGS. 1D, 2, 6A-6F, and/or 7A-7F.

The method 700 can proceed to decision block 724, where it is determined if additional layers (e.g., base coatings or sintered metal layers) are desired. If additional layers are desired, the method 700 can proceed from decision block 724 back to start 702 to restart the method. Alternatively, if additional layers are not desired, the method 700 can proceed from decision block 724 to terminator 726, where the sintered metal layer serves to repair, recondition, and/or replace the existing pipe.

Although some of blocks 702-726 of method 700 have been described as being performed once, in some embodiments, multiple repetitions of a particular process block may be employed before proceeding to the next decision block or process block. In addition, although blocks 702-726 of method 700 have been separately illustrated and described, in some embodiments, process blocks may be combined and performed together (simultaneously or sequentially). For example, the drying of process block 716 can be combined with the subjecting to second temperature of process block 720. Moreover, although FIG. 9 illustrates a particular order for blocks 702-726, embodiments of the disclosed subject matter are not limited thereto. Indeed, in certain embodiments, the blocks may occur in a different order than illustrated or simultaneously with other blocks.

### Self-Repairing Sintered Metal Pipe Coatings

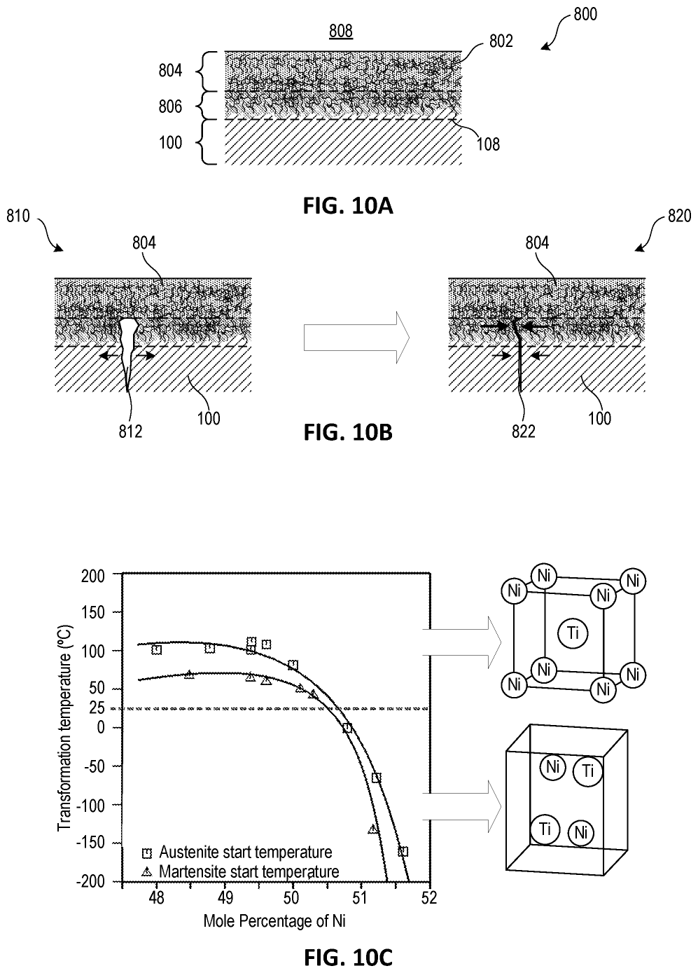

In some embodiments, the slurry can include particles or fibers of a shape memory alloy (SMA) in addition to the metal powder, the binder, and the solvent. After sintering such a slurry, the resulting metal layer can exhibit self-healing properties, for example, to close cracks or defects (e.g., <1 mm, such as ≤100-500 μm) when subjected to a temperature greater than a transition temperature (e.g., 25° C.) of the SMA. For example, FIG. 10A illustrates a pipe-in-pipe configuration 800 employing a radially-inner sintered layer 804 with SMA fibers 802 therein bounding an inner volume 808, an existing pipe 100, and an optional intermediate layer 806 (e.g., transition layer) between the existing pipe 100 and the sintered layer 804. In some embodiments, the SMA can comprise copper-aluminum-nickel (Cu—Al—Ni), nickel-titanium (NiTi), iron-manganese-silicon (Fe—Mn—Si), copper-zinc-aluminum (Cu—Zn—Al), copper-aluminum-nickel (Cu—Al—Ni), or any combination thereof.

Once placed in service, the sintered layer 804, the intermediate layer 806, and/or the existing pipe 100 may develop cracks or defects 812 over time (e.g., decades), as shown at 810 in FIG. 10B. For example, for temperatures below its transition temperature (e.g., 25° C.), NiTi SMA can be in the form of B19′ martensite, as shown in FIG. 10C. However, once the temperature is raised above its transition temperature, the NiTi SMA can convert to the austenite B2 parent phase, which in turn induces a self-healing force with a strain recovery, for example, of at least 8%. The strain recovery can be effective to close or seal the cracks/defects 822, as shown at 820 in FIG. 10B.

In some embodiments, the heating of the sintered layer 804 above the SMA transition temperature can be achieved by heating the entire pipe, for example, by heating the fluid conveyed through inner volume 808. Alternatively or additionally, the heating above the SMA transition temperature can result from seasonal temperature variations, for example, due to hotter temperatures during the summer. Alternatively or additionally, the heating above the SMA transition temperature can be provided by local heating, for example, by employing a sintering head (e.g., similar to any of the heating elements described above) and/or by using as separate robot (e.g., pipe crawler) that locally applies heat to an area with a detected crack or defect.

### Fabricated Examples and Experimental Results

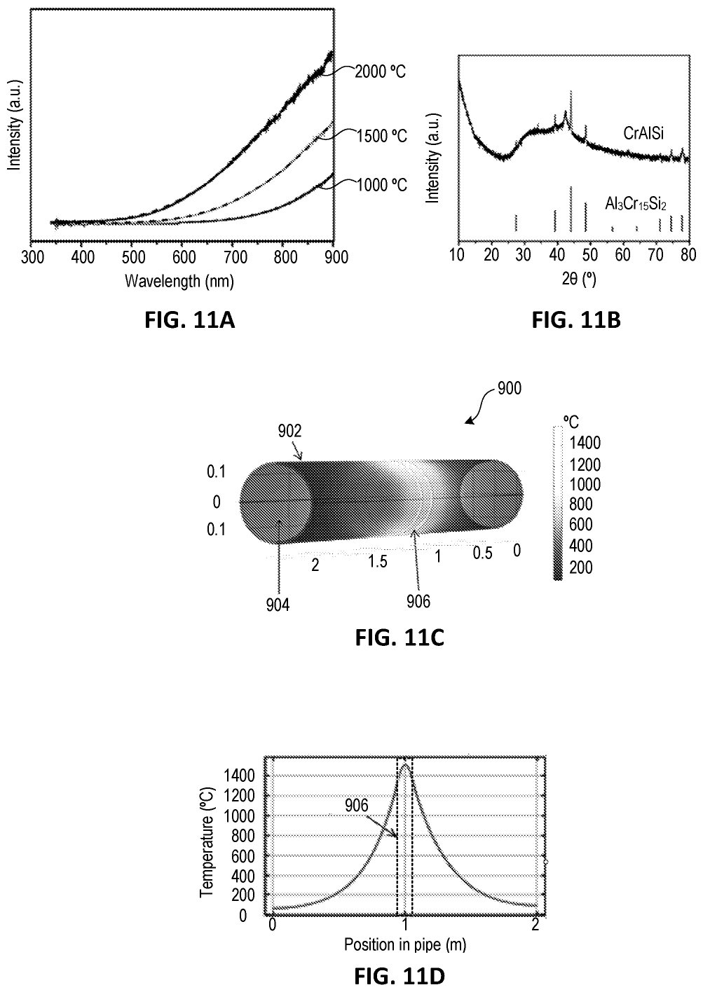

In some embodiments, a Joule heating element (e.g., a carbon heating bar) can rapidly change temperature from room temperature (e.g., ˜20-25° C.) to a sintering temperature (e.g., ≥1500-2000° C.) in a relatively short amount of time (e.g., ˜100 ms). The sintering temperature and time can be controlled such that the slurry layer coated on the existing pipe wall can be sintered into a dense metal layer (e.g., steel) without oxides, for example, due to the inert environment (e.g., methane gas flow or a shielding gas flow of inert gas) within the existing pipe. For example, a Joule heating element was placed at a close distance (e.g., ˜4 mm) and scanned over the coated layer of metal precursor powder. As shown by FIG. 11A, the broad radiative heating can lead to efficient heat absorption of the metal precursor powder. As a result, the powder melts quickly. After removal of the heat (e.g., by de-energizing the heating element and/or movement of the heating element), the melted powder can solidify into a dense sintered layer.

In some embodiments, high-temperature radiation sintering (HRS) can rapidly sinter alloys directly from metal precursor powder. For example, in some embodiments, a mixture of elemental powders can be used to synthesize and sinter alloys in a single step. In a fabricated example, CrAlSi (6-3-1) alloy was sintered from a micro-powder pellet composed of elemental Cr, Al, and Si. After rapid HRS sintering at ˜1800° C. for ˜10 s, the micro-powder pellet layer, with a thickness of ˜1 mm, was converted into a shiny and dense structure (e.g., after polishing). As shown in FIG. 11B, the X-ray powder diffraction (XRD) pattern confirms the successful synthesis of the alloy phase from the mixture of the raw metal powders. Cross-sectional scanning electron microscopy (SEM) images and energy dispersive X-ray spectroscopy (EDS) mapping also confirm the resulting dense structure. In particular, the EDS mapping results show dendritic silicide and aluminide phases, as well as uniformly distributed Cr, which further confirms the thorough reactions and diffusions between the elemental powers during the rapid HRS sintering. Thus, by mixing pure elements, similar sintering effects can be achieved with pre-alloyed powders, which can provide more material powder choices for coating. Note that no oxides were observed due to the inert atmosphere using carbon felt as a heating element.

In some embodiments, HRS can be used to rapidly sinter a wide range of metals and alloys, such as, but not limited to, Al, Ti, Cu, Fe, stainless steel, refractory metals (e.g., W, Zr, Nb, Mo), and silicides (e.g., NbSi₂, MoSi₂, TiSi₂). Sintered layers were all formed (e.g., directly sintered) from mixtures of corresponding elemental powders. The sintering temperature of these metals and alloys varies from ˜1000 to ˜3000° C., resulting in sintered dense structures. In addition to single-composition pellets, in some embodiments, HRS can be applied to co-sinter multi-materials, for example, as demonstrated by the formation of a Cu/Fe bilayer.

In another fabricated example, steel powder (powder mixture of elemental metals, e.g., Fe, Mn, Ni, Cr, 1-5 μm powder size) with 3-5 wt % polymer binder was dispersed in ethanol to make a slurry. The viscosity of the slurry can be controlled by tuning the concentration of the metal powders and polymer binder for different coating techniques, including spray coating and the doctor blade method. The powder slurry was deposited as a coating with a wet thickness of ˜5 mm on a steel disc. The resulting coating had a dark and porous morphology. After the coating layer was dried in air, a carbon heating bar was moved over the coating in close proximity thereto, while generating a temperature of ˜1500° C., thereby sintering the coating into a dense steel layer. The sintered coating forms a dense and shiny steel after about 5 s of heating by the carbon heating bar. A cross-sectional SEM image of the coating indicated that the sintered steel is ˜1 mm thick, dense, and has a tight binding with the steel substrate.

In some embodiments, the sintering process can employ a well-controlled thermal zone in which the metal powders are converted into a dense, structural alloy. In addition, robotic components within the pipeline must remain within their specified temperature limits, and high temperatures resulting from the sintering process should not weaken the original pipe, boil off ground water, damage joints, etc. In some embodiments, the high temperatures offered by the Joule heating element can be used to clean the existing pipe prior to slurry deposition and sintering, for example, to drive off in-pipe water and/or remove surface contamination.

To provide a quantitative understanding of the thermal conditions within the pipe, a thermal model 900 of the sintering zone as well as the surrounding pipe environment was constructed. The steady-state heat transfer model of the pipe can be constructed for a variety of lengths (e.g., 1-500 m), with heat generation in a central section 906 having a width (e.g., along the axial direction) of 10 cm for a range of heating rates (e.g., from 5-250 kW), assuming a pipe and soil series thermal resistance 902 of 1 W/m²-K and forced convection 904 through the pipe of N₂ gas at 1 m/s. FIGS. 11C-11D show results of the heat transfer model for a heating rate of 5 kW, which corresponds to a coating thickness of 0.4 mm at a rate of 15 m/hour in a pipe of diameter 0.25 meters (10″). While there are substantial differences between the disclosed sintering process for pipe repair and the steady-state model 900, but the results provide an indication regarding important length scales and principal directions of heat flow. For example, axial conduction through the pipe is limited by the small cross-sectional area of the pipe itself. In other words, the width of the “hot zone” 906 should be modest, which is important to keep the robotic pipe repair platform within its required temperature, as well as to improve the energy efficiency of the process.

### Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. A method comprising:
(a) applying a first slurry over a surface of an existing pipe to form a first layer, the first slurry comprising a powder, a binder, and a solvent; and
(b) after (a), sintering at least some of the powder in the first layer to form a new pipe portion by subjecting a portion of the first layer to a first temperature for a first time period,
wherein the powder comprises a metal, and
the first temperature is greater than a melting temperature of the metal.
   Clause 2. The method of any clause or example herein, in particular, Clause 1, wherein the first temperature is greater than or equal to 1500° C.
   Clause 3. The method of any clause or example herein, in particular, any one of Clauses 1-2, wherein the first temperature is approximately 2000° C.
   Clause 4. The method of any clause or example herein, in particular, any one of Clauses 1-3, wherein a duration of the first time period is less than or equal to 60 s.
   Clause 5. The method of any clause or example herein, in particular, any one of Clauses 1-4, wherein the duration of the first time period is approximately 10 s.
   Clause 6. The method of any clause or example herein, in particular, any one of Clauses 1-5, wherein the powder comprises particles of the metal having an average particle size less than or equal to 150 μm.
   Clause 7. The method of any clause or example herein, in particular, any one of Clauses 1-6, wherein the average particle size of the particles of the metal is approximately 50 μm.
   Clause 8. The method of any clause or example herein, in particular, any one of Clauses 1-5, wherein the powder comprises particles of the metal having a bimodal distribution of average particle sizes, with a first subset of the particles having an average particle size less than or equal to 10 μm and a second subset of the particles having an average particle size greater than 10 μm.
   Clause 9. The method of any clause or example herein, in particular, Clause 8, wherein (i) the average particle size of the first subset is approximately 5 um, (ii) the average particle size of the second subset is approximately 50 μm, or both (i) and (ii).
   Clause 10. The method of any clause or example herein, in particular, any one of Clauses 1-9, wherein the subjecting the first layer to the first temperature comprises:
heating using a Joule heating element formed of carbon, silicon carbide, a metal, or any combination of the foregoing;
at a beginning of the first time period, a heating ramp rate of at least 104° C./s to the first temperature;
at an end of the first time period, a cooling ramp rate of at least 104° C./s from the first temperature;
displacing a heating element around an inner circumference of the existing pipe to sinter other portions of the first layer; or
any combination of the above.
   Clause 11. The method of any clause or example herein, in particular, any one of Clauses 1-10, wherein:
the heating element has a curved configuration;
during (b), a spacing along a radial direction of the existing pipe between the heating element and the first layer is less than or equal to 5 mm;
during (b), at least a portion of the heating element is in contact with the first layer; or
any combination of the above.
   Clause 12. The method of any clause or example herein, in particular, any one of Clauses 1-11, wherein, in (a), the first slurry has a viscosity of 0.5 Pa-s to 5 Pa-s, inclusive.
   Clause 13. The method of any clause or example herein, in particular, any one of Clauses 1-12, wherein the binder comprises a polymeric binder.
   Clause 14. The method of any clause or example herein, in particular, any one of Clauses 1-13, wherein the binder comprises a wax, a water-soluble polymer, or any combination of the foregoing.
   Clause 15. The method of any clause or example herein, in particular, any one of Clauses 1-14, wherein the binder comprises polyvinyl alcohol (PVA), poly(vinylpolypyrrolidone) (PVP), or both PVA and PVP.
   Clause 16. The method of any clause or example herein, in particular, any one of Clauses 1-15, wherein, prior to (b), a content of the binder within the first slurry is less than or equal to 5wt %.
   Clause 17. The method of any clause or example herein, in particular, any one of Clauses 1-16, wherein a content of the binder within the first slurry is 1-5 wt %, inclusive.
   Clause 18. The method of any clause or example herein, in particular, any one of Clauses 1-17, wherein the solvent comprises an organic solvent.
   Clause 19. The method of any clause or example herein, in particular, any one of Clauses 1-18, wherein the solvent comprises an alcohol solvent.
   Clause 20. The method of any clause or example herein, in particular, any one of Clauses 1-19, wherein the solvent comprises methanol, ethanol, isopropyl alcohol (IPA), acetone, or any combination of the foregoing.
   Clause 21. The method of any clause or example herein, in particular, any one of Clauses 1-20, wherein the applying of (a) forms the first layer with a thickness of 5 mm or less along a radial direction of the existing pipe.
   Clause 22. The method of any clause or example herein, in particular, any one of Clauses 1-21, wherein the applying of (a) comprises brushing the first slurry, printing the first slurry, extruding the first slurry, spreading the first slurry, or any combination of the foregoing.
   Clause 23. The method of any clause or example herein, in particular, any one of Clauses 1-22, further comprising, after (a) and prior to (b):
(c) densifying the first layer by pressing along a radial direction of the existing pipe toward the surface of the existing pipe.
   Clause 24. The method of any clause or example herein, in particular, Clause 23, wherein the pressing of (c) comprises using a roller.
   Clause 25. The method of any clause or example herein, in particular, Clause 24, wherein the roller comprises a glass, a ceramic, a polymer, or any combination of the foregoing.
   Clause 26. The method of any clause or example herein, in particular, Clause 25, wherein the polymer comprises polypropylene, polytetrafluoroethylene, or any combination of the foregoing.
   Clause 27. The method of any clause or example herein, in particular, any one of Clauses 23-26, wherein a thickness of the first layer along a radial direction of the existing pipe after (c) is at least 10% less than that of the first layer prior to (c).
   Clause 28. The method of any clause or example herein, in particular, any one of Clauses 23-27, wherein:
prior to (c), the first layer has a thickness along a radial direction of the existing pipe of approximately 3 mm; and
after (c), the first layer has a thickness along the radial direction of approximately 2.5 mm.
   Clause 29. The method of any clause or example herein, in particular, any one of Clauses 1-28, further comprising, after (a) and prior to (b), drying the first layer so as to remove at least some of the solvent from the first slurry.
   Clause 30. The method of any clause or example herein, in particular, Clause 29, wherein the drying comprises air drying, forced air flow, infrared irradiation, or any combination of the foregoing.
   Clause 31. The method of any clause or example herein, in particular, any one of Clauses 1-30, further comprising, after (a) and before (b), subjecting the first layer to a second temperature for a second time period, the second temperature being less than the first temperature.
   Clause 32. The method of any clause or example herein, in particular, Clause 31, wherein the second temperature is less than a melting temperature of the metal.
   Clause 33. The method of any clause or example herein, in particular, any one of Clauses 31-32, wherein the second temperature is less than 1500° C.
   Clause 34. The method of any clause or example herein, in particular, any one of Clauses 31-33, wherein the first temperature is approximately 2000° C. and the second temperature is approximately 1000° C.
   Clause 35. The method of any clause or example herein, in particular, any one of Clauses 31-34, wherein the first time period begins at an end of the second time period.
   Clause 36. The method of any clause or example herein, in particular, any one of Clauses 31-35, wherein a duration of the first time period, a duration of the second time period, or both are less than or equal to 60 s.
   Clause 37. The method of any clause or example herein, in particular, any one of Clauses 31-36, wherein a duration of the first time period, a duration of the second time period, or both are approximately 10 s.
   Clause 38. The method of any clause or example herein, in particular, any one of Clauses 1-37, further comprising, prior to (a), forming an intermediate layer over the surface of the existing pipe, wherein the first layer is formed on the intermediate layer.
   Clause 39. The method of any clause or example herein, in particular, Clause 38, wherein the intermediate layer comprises an insulating material, a porous layer, an oxide, un-sintered slurry, or any combination of the foregoing.
   Clause 40. The method of any clause or example herein, in particular, any one of Clauses 38-39, wherein the intermediate layer comprises an oxide having a melting temperature greater than that of the metal.
   Clause 41. The method of any clause or example herein, in particular, any one of Clauses 38-40, wherein the intermediate layer comprises silicon dioxide, aluminum oxide, titanium dioxide, boron nitride, or any combination of the foregoing.
   Clause 42. The method of any clause or example herein, in particular, any one of Clauses 38-41, wherein a thermal conductivity of the first layer is greater than a thermal conductivity of the intermediate layer.
   Clause 43. The method of any clause or example herein, in particular, any one of Clauses 1-42, further comprising, after (b):
applying a second slurry over the first layer to form a second layer, the second slurry having a composition that is the same as or different from that of the first slurry; and
sintering at least some of a powder in the second layer by subjecting a portion of the second layer to a third temperature for a third time period, the third temperature being greater than a melting temperature of a metal of the powder in the second layer.
   Clause 44. The method of any clause or example herein, in particular, Clause 43, wherein the third temperature is the same as the first temperature, a duration of the first time period is the same as a duration of the third time period, the third temperature is greater than or equal to 1500° C., the duration of the third time period is less than or equal to 60 s, or any combination of the foregoing.
   Clause 45. The method of any clause or example herein, in particular, any one of Clauses 1-44, wherein the sintering is such that, after (b), a transition layer is formed from the first slurry and is disposed between the new pipe portion and the existing pipe along a radial direction of the existing pipe.
   Clause 46. The method of any clause or example herein, in particular, any one of Clauses 1-45, wherein the sintering is such that, after (b), the new pipe portion has at least one material property that varies along a radial direction of the existing pipe.
   Clause 47. The method of any clause or example herein, in particular, Clause 46, wherein the material property comprises density, yield strength, hardness, or any combination of the foregoing.
   Clause 48. The method of any clause or example herein, in particular, any one of Clauses 1-47, wherein the sintering is such that, after (b), a first part of the new pipe portion distal from the existing pipe along a radial direction of the existing pipe has a density that is greater than that of a second part proximal to the existing pipe along the radial direction.
   Clause 49. The method of any clause or example herein, in particular, any one of Clauses 1-48, wherein the surface is an inner circumferential surface of the existing pipe, and, after (b), the new pipe portion is formed in situ within the existing pipe.
   Clause 50. The method of any clause or example herein, in particular, any one of Clauses 1-49, wherein during (a), during (b), or during both (a) and (b), the existing pipe is buried underground.
   Clause 51. The method of any clause or example herein, in particular, any one of Clauses 1-50, wherein during (a), during (b), or during both (a) and (b), a gas is conveyed through the existing pipe.
   Clause 52. The method of any clause or example herein, in particular, Clause 51, wherein the gas comprises methane.
   Clause 53. The method of any clause or example herein, in particular, any one of Clauses 1-52, wherein during (a), during (b), or during both (a) and (b), a gas is conveyed to an exposed surface of the first layer.
   Clause 54. The method of any clause or example herein, in particular, Clause 53, wherein the gas comprises an inert gas.
   Clause 55. The method of any clause or example herein, in particular, any one of Clauses 53-54, wherein the gas comprises nitrogen, argon, helium, neon, krypton, xenon, radon, oganesson, or any combination of the foregoing.
   Clause 56. The method of any clause or example herein, in particular, any one of Clauses 1-55, wherein the first slurry further comprises fibers or particles formed of a shape-memory alloy (SMA).
   Clause 57. The method of any clause or example herein, in particular, Clause 56, wherein the SMA comprises copper-aluminum-nickel (Cu-Al-Ni), nickel-titanium (NiTi), iron-manganese-silicon (Fe—Mn—Si), copper-zinc-aluminum (Cu—Zn—Al), copper-aluminum-nickel (Cu—Al—Ni), or any combination of the foregoing.
   Clause 58. The method of any clause or example herein, in particular, any one of Clauses 56-57, further comprising, after (b):
(d) heating the SMA within the new pipe portion to a temperature greater than a transition temperature of the SMA so as to cause self-healing of a crack in the new pipe portion.
   Clause 59. The method of any clause or example herein, in particular, Clause 58, wherein the heating of (d) is via naturally-occurring weather patterns, heating a fluid flowing through the new pipe portion, local heating via a robot within the new pipe portion, or any combination of the foregoing.
   Clause 60. The method of any clause or example herein, in particular, any one of Clauses 58-59, wherein the transition temperature is approximately 25° C.
   Clause 61. The method of any clause or example herein, in particular, any one of Clauses 1-60, wherein:
the sintered first layer forming the new pipe portion is effective to repair or recondition the existing pipe;
the sintered first layer forming the new pipe portion forms at least part of a separate pipe within and contacting the existing pipe; or
both of the above.
   Clause 62. The method of any clause or example herein, in particular, any one of Clauses 1-61, further comprising, after (b), removing the existing pipe from the new pipe portion.
   Clause 63. A pipe within an existing pipe formed by the method of any clause or example herein, in particular, any one of Clauses 1-62.
   Clause 64. A structure comprising:
a first pipe; and
a second pipe comprising a sintered layer of metal formed in situ over an inner circumferential wall of the first pipe.
   Clause 65. The structure of any clause or example herein, in particular, Clause 64, the second pipe being coaxial with the first pipe.
   Clause 66. The structure of any clause or example herein, in particular, any one of Clauses 64-65, wherein a material of the first pipe is different from a material of the second pipe.
   Clause 67. The structure of any clause or example herein, in particular, any one of Clauses 64-66, wherein the second pipe comprises steel, aluminum, titanium, a shape-memory alloy, or any combination of the foregoing.
   Clause 68. The structure of any clause or example herein, in particular, any one of Clauses 64-67, wherein a thickness of the sintered layer along a radial direction of the first pipe is less than or equal to 5 mm.
   Clause 69. The structure of any clause or example herein, in particular, any one of Clauses 64-68, wherein the second pipe further comprises an intermediate layer disposed along a radial direction of the first pipe between the inner circumferential wall and the sintered layer.
   Clause 70. The structure of any clause or example herein, in particular, Clause 69, wherein the intermediate layer comprises an insulating material, a porous layer, an oxide, un-sintered slurry, or any combination of the foregoing.
   Clause 71. The structure of any clause or example herein, in particular, any one of Clauses 69-70, wherein the intermediate layer comprises an oxide having a melting temperature greater than that of the metal.
   Clause 72. The structure of any clause or example herein, in particular, any one of Clauses 69-71, wherein the intermediate layer comprises silicon dioxide, aluminum oxide, titanium dioxide, boron nitride, or any combination of the foregoing.
   Clause 73. The structure of any clause or example herein, in particular, any one of Clauses 69-72, wherein a thermal conductivity of the sintered layer is greater than a thermal conductivity of the intermediate layer.
   Clause 74. The structure of any clause or example herein, in particular, any one of Clauses 64-73, wherein the second pipe further comprises a second sintered layer disposed along a radial direction of the first pipe between the inner circumferential wall and the sintered layer.
   Clause 75. The structure of any clause or example herein, in particular, any one of Clauses 64-74, wherein the second pipe further comprises a transition layer disposed along a radial direction of the first pipe between the inner circumferential wall and the sintered layer.
   Clause 76. The structure of any clause or example herein, in particular, any one of Clauses 64-75, wherein the second pipe has at least one material property that varies along a radial direction of the first pipe.
   Clause 77. The structure of any clause or example herein, in particular, Clause 76, wherein the material property comprises density, yield strength, hardness, or any combination of the foregoing.
   Clause 78. The structure of any clause or example herein, in particular, any one of Clauses 64-77, wherein a radially-inner part of the second pipe has a density that is greater than that of a radially-outer part of the second pipe.
   Clause 79. A pipe repair system comprising:
a slurry application device;
a sintering device; and
a control system operatively coupled to the slurry application device and the sintering device, the control system comprising one or more processors and computer readable storage media storing instructions that, when executed by the one or more processors, cause the control system to:
   control the slurry application device to apply a first slurry over a surface of an existing pipe to form a first layer, the first slurry comprising a powder, a binder, and a solvent; and
   control the sintering device to sinter at least some of the powder in the first layer to form a new pipe portion by subjecting a portion of the first layer to a first temperature for a first time period, the first temperature being greater than a melting temperature of a metal of the powder.
      Clause 80. The pipe repair system of any clause or example herein, in particular, Clause 79, wherein the computer readable storage media stores additional instructions that, when executed by the one or more processors, cause the control system to control the sintering device such that:
the first temperature is greater than or equal to 1500° C.;
the first temperature is approximately 2000° C.;
a duration of the first time period is less than or equal to 60 s;
a duration of the first time period is approximately 10 s;
at a beginning of the first time period, a heating ramp rate to the first temperature is at least 10⁴° C./s;
at an end of the first time period, a cooling ramp rate from the first temperature is at least 10⁴° C./s; or
any combination of the above.
   Clause 81. The pipe repair system of any clause or example herein, in particular, any one of Clauses 79-80, wherein the sintering device comprises a Joule-heating element formed of carbon, silicon carbide, a metal, or any combination of the foregoing.
   Clause 82. The pipe repair system of any clause or example herein, in particular, any one of Clauses 79-81, further comprising:
one or more actuators coupled to the slurry application device, the sintering device, or both,
wherein the control system is operatively coupled to the one or more actuators, and the computer readable storage media stores additional instructions that, when executed by the one or more processors, cause the control system to move, via the one or more actuators, the slurry application device, the sintering device, or both around an inner circumference of the existing pipe.
   Clause 83. The pipe repair system of any clause or example herein, in particular, any one of Clauses 79-82, wherein the sintering device comprises a heating element with a curved configuration.
   Clause 84. The pipe repair system of any clause or example herein, in particular, any one of Clauses 79-83, wherein the sintering device comprises a heating element that, when viewed along an axial direction of the existing pipe, is U-shaped, V-shaped, W-shaped, oval-shaped, or rod-shaped.
   Clause 85. The pipe repair system of any clause or example herein, in particular, any one of Clauses 79-84, wherein the sintering device comprises first and second heating elements spaced from each other along a circumferential direction of the existing pipe, and the computer readable storage media stores additional instructions that, when executed by the one or more processors, cause the control system to control the first heating element to generate the first temperature and the second heating element to generate a second temperature less than the first temperature.
   Clause 86. The pipe repair system of any clause or example herein, in particular, Clause 85, the computer readable storage media stores additional instructions that, when executed by the one or more processors, cause the control system to control the sintering device such that:
the second temperature is less than the melting temperature of the metal;
the second temperature is less than 1500° C.;
the first time period begins at an end of a second time period during which the second temperature is applied;
a duration of the first time period, a duration of the second time period, or both are less than or equal to 60 s;
the duration of the first time period, the duration of the second time period, or both are approximately 10 s; or
any combination of the above.
   Clause 87. The pipe repair system of any clause or example herein, in particular, any one of Clauses 79-86, wherein the slurry application device comprises a brush, an extrusion nozzle, a printhead, a dispensing conduit, a doctor blade, a spatula, or any combination of the foregoing.
   Clause 88. The pipe repair system of any clause or example herein, in particular, any one of Clauses 79-87, further comprising a densifying device constructed to press radially outward toward the surface of the existing pipe.
   Clause 89. The pipe repair system of any clause or example herein, in particular, Clause 88, wherein the densifying device comprises a roller formed of a glass, ceramic, polymer, or any combination of the foregoing.
   Clause 90. The pipe repair system of any clause or example herein, in particular, any one of Clauses 88-89, wherein the control system is operatively coupled to the densifying device and the computer readable storage media stores additional instructions that, when executed by the one or more processors, cause the control system to control the densifying device to press the first layer prior to sintering by the sintering device.
   Clause 91. The pipe repair system of any clause or example herein, in particular, any one of Clauses 79-90, further comprising:
a layer formation device constructed to form an insulating material, a porous layer, an oxide, or any combination of the foregoing,
wherein the control system is operatively coupled to the layer formation device and the computer readable storage media stores additional instructions that, when executed by the one or more processors, cause the control system to control the layer formation device to form an intermediate layer over the surface of the existing pipe prior to applying the first slurry.
   Clause 92. The pipe repair system of any clause or example herein, in particular, any one of Clauses 79-91, wherein the computer readable storage media stores additional instructions that, when executed by the one or more processors, cause the control system to:
control the slurry application device to apply a second slurry over the first layer to form a second layer; and
control the sintering device to sinter at least some of a powder in the second layer by subjecting a portion of the second layer to a third temperature for a third time period, the third temperature being greater than a melting temperature of a metal of the powder in the second layer.
   Clause 93. The pipe repair system of any clause or example herein, in particular, Clause 92, the computer readable storage media stores additional instructions that, when executed by the one or more processors, cause the control system to control the sintering device such that:
the third temperature is the same as the first temperature;
a duration of the first time period is the same as a duration of the third time period;
the third temperature is greater than or equal to 1500° C.;
the duration of the third time period is less than or equal to 60 s;
or any combination of the foregoing.

### Conclusion

Any of the features illustrated or described herein, for example, with respect to FIGS. 1A-11D and Clauses 1-93, can be combined with any other feature illustrated or described herein, for example, with respect to FIGS. 1A-11D and Clauses 1-93 to provide systems, devices, structures, methods, and embodiments not otherwise illustrated or specifically described herein. For example, the curved heating elements of FIGS. 6A-6F can be applied to any of the systems or repair configurations of FIGS. 1A-5B and 7A-11D. In another example, the self-healing sintered pipe layer of FIGS. 10A-10C can be applied to any of the systems or repair configurations of FIGS. 1A-9 and 11A-11D. Other combinations and variations are also possible according to one or more contemplated embodiments. Indeed, all features described herein are independent of one another and, except where structurally impossible, can be used in combination with any other feature described herein.

In view of the many possible embodiments to which the principles of the disclosed technology may be applied, it should be recognized that the illustrated embodiments are only examples and should not be taken as limiting the scope of the disclosed technology. Rather, the scope is defined by the following claims. We therefore claim all that comes within the scope and spirit of these claims.

1. A method comprising:
(a) applying a first slurry over a surface of an existing pipe to form a first layer, the first slurry comprising a powder, a binder, and a solvent; and
(b) after (a), sintering at least some of the powder in the first layer to form a new pipe portion by subjecting a portion of the first layer to a first temperature for a first time period,
wherein the powder comprises a metal, and
the first temperature is greater than a melting temperature of the metal.

2. The method of claim 1, wherein:
the first temperature is greater than or equal to 1500° C.;
a duration of the first time period is less than or equal to 60 s; and
the powder comprises particles of the metal having an average particle size less than or equal to 150 μm.

3-7. (canceled).

8. The method of claim 1, wherein the powder comprises particles of the metal having a bimodal distribution of average particle sizes, with a first subset of the particles having an average particle size less than or equal to 10 μm and a second subset of the particles having an average particle size greater than 10 μm.

9. (canceled).

10. The method of claim 1, wherein the subjecting the first layer to the first temperature comprises:
heating using a Joule heating element formed of carbon, silicon carbide, a metal, or any combination of the foregoing;
at a beginning of the first time period, a heating ramp rate of at least 10⁴° C./s to the first temperature;
at an end of the first time period, a cooling ramp rate of at least 10⁴° C./s from the first temperature;
displacing a heating element around an inner circumference of the existing pipe to sinter other portions of the first layer; or
any combination of the above.

11. The method of claim 10, wherein:
the heating element has a curved configuration;
during (b), a spacing along a radial direction of the existing pipe between the heating element and the first layer is less than or equal to 5 mm;
during (b), at least a portion of the heating element is in contact with the first layer; or
any combination of the above.

12-22. (canceled).

23. The method of claim 1, further comprising, after (a) and prior to (b):
(c) densifying the first layer by pressing along a radial direction of the existing pipe toward the surface of the existing pipe,
wherein the pressing of (c) comprises using a roller, and
a thickness of the first layer along a radial direction of the existing pipe after (c) is at least 10% less than that of the first layer prior to (c).

24-30. (canceled).

31. The method of claim 1, further comprising, after (a) and before (b), subjecting the first layer to a second temperature for a second time period, the second temperature being less than the first temperature and less than the melting temperature of the metal.

32-42. (canceled).

43. The method of claim 1, further comprising, after (b):
applying a second slurry over the first layer to form a second layer, the second slurry having a composition that is the same as or different from that of the first slurry; and
sintering at least some of a powder in the second layer by subjecting a portion of the second layer to a third temperature for a third time period, the third temperature being greater than a melting temperature of a metal of the powder in the second layer.

44-48. (canceled).

49. The method of claim 1, wherein the surface is an inner circumferential surface of the existing pipe, and, after (b), the new pipe portion is formed in situ within the existing pipe.

50. (canceled).

51. The method of claim 1, wherein during (a), during (b), or during both (a) and (b), a gas is conveyed through the existing pipe, and the gas comprises methane.

52. (canceled).

53. The method of claim 1, wherein during (a), during (b), or during both (a) and (b), a gas is conveyed to an exposed surface of the first layer, and the gas comprises an inert gas.

54-55. (canceled).

56. The method of claim 1, wherein the first slurry further comprises fibers or particles formed of a shape-memory alloy (SMA), and the SMA comprises copper-aluminum-nickel (Cu—Al—Ni), nickel-titanium (NiTi), iron-manganese-silicon (Fe—Mn—Si), copper-zinc-aluminum (Cu—Zn—Al), copper-aluminum-nickel (Cu—Al—Ni), or any combination of the foregoing.

57. (canceled).

58. The method of claim 56, further comprising, after (b):
(d) heating the SMA within the new pipe portion to a temperature greater than a transition temperature of the SMA so as to cause self-healing of a crack in the new pipe portion,
wherein the heating of (d) is via naturally-occurring weather patterns, heating a fluid flowing through the new pipe portion, local heating via a robot within the new pipe portion, or any combination of the foregoing.

59-61. (canceled).

62. The method of claim 1, further comprising, after (b), removing the existing pipe from the new pipe portion.

63. (canceled).

64. A structure comprising:
a first pipe; and
a second pipe comprising a sintered layer of metal formed in situ over an inner circumferential wall of the first pipe.

65-67. (canceled).

68. The structure of claim 64, wherein:
the second pipe further comprises an intermediate layer disposed along a radial direction of the first pipe between the inner circumferential wall and the sintered layer; and
the intermediate layer comprises an insulating material, a porous layer, an oxide, un-sintered slurry, or any combination of the foregoing.

69-77. (canceled).

78. A pipe repair system comprising:
a slurry application device;
a sintering device; and
a control system operatively coupled to the slurry application device and the sintering device, the control system comprising one or more processors and computer readable storage media storing instructions that, when executed by the one or more processors, cause the control system to:
control the slurry application device to apply a first slurry over a surface of an existing pipe to form a first layer, the first slurry comprising a powder, a binder, and a solvent; and
control the sintering device to sinter at least some of the powder in the first layer to form a new pipe portion by subjecting a portion of the first layer to a first temperature for a first time period, the first temperature being greater than a melting temperature of a metal of the powder.

79. The pipe repair system of claim 78, wherein the computer readable storage media stores additional instructions that, when executed by the one or more processors, cause the control system to control the sintering device such that:
the first temperature is greater than or equal to 1500° C.;
the first temperature is approximately 2000° C.;
a duration of the first time period is less than or equal to 60 s;
a duration of the first time period is approximately 10 s;
at a beginning of the first time period, a heating ramp rate to the first temperature is at least 10⁴° C./s;
at an end of the first time period, a cooling ramp rate from the first temperature is at least 10⁴° C./s; or
any combination of the above.

80. (canceled).

81. The pipe repair system of claim 78, further comprising:
one or more actuators coupled to the slurry application device, the sintering device, or both,
wherein the control system is operatively coupled to the one or more actuators, and the computer readable storage media stores additional instructions that, when executed by the one or more processors, cause the control system to move, via the one or more actuators, the slurry application device, the sintering device, or both around an inner circumference of the existing pipe.

82-86. (canceled).

87. The pipe repair system of claim 78, further comprising a densifying device constructed to press radially outward toward the surface of the existing pipe.

88-92. (canceled).
